(19) United States
(12) Patent Application Publication
(10) Pub. No.: US 2009/0215285 A1
(43) Pub. Date: Aug. 27, 2009

(54) CIRCUIT CARD CONNECTOR ARRANGEMENT FOR IMPROVED CARD INSERTION/REMOVAL DETECTION

(75) Inventors: Simon Creasy, Ottawa (CA); Michel Patoine, Ashton (CA)

Correspondence Address: MARKS & CLERK, P.O. BOX 957, STATION B, OTTAWA, ON, K1P 5S7, CA

(73) Assignee: ALCATEL LUCENT, Paris (FR)

(21) Appl. No.: 12/034,887

(22) Filed: Feb. 21, 2008

(51) Int. Cl. H01R 12/14

(52) U.S. Cl. 439/60

(57) ABSTRACT

A circuit card connector arrangement is provided, wherein one of the connectors on the card is recessed relative to the other connectors. Using this arrangement, insertion and extraction detection of the card into another card is optimized without the need for a short pin on the other card. The recessed connector is the last connector on the card to make electrical contact with the other card upon insertion and the first connector to lose electrical contact with the other card upon extraction. Since the degree of recess and the choice of which connector is recessed is made by the designer of the inserted card rather than dependent on the design of the main card or board, such as a backplane, onto which the card is inserted, greater flexibility is possible in the design of the card and of the insertion/extraction circuitry on the card. In addition, insertion and extraction can be detected even if the main board does not have a short pin, such as occurs in some legacy system.

### FIELD OF THE INVENTION

The invention relates to connectors for circuit cards, and more particularly to the arrangement of connectors and pins.

### BACKGROUND OF THE INVENTION

Circuit cards are typically connected to each other using connectors, the connector on one card being “male” and the connector on the other card being “female”. A common example is insertion of a circuit card onto a backplane of a computer, in which the backplane has male connectors having pins and the circuit card has female connectors having holes. When fully inserted, the pins of one connector are inside and make electrical contact with the holes of the other connector.

It is important that the circuit card be properly inserted into the motherboard. If not all the pins are making contact with the electrical contacts within the corresponding holes, then the circuit card may appear faulty. Another problem may occur if the circuit card begins to power up and make intermittent contact with the backplane during insertion but before full insertion, in which case incorrect signals may disrupt the system. Similarly, if signals are still passing between the circuit card and the backplane during card extraction while only some pins are making electrical contact, incorrect signals may disrupt the system.

It is therefore important to provide confirmation of insertion only upon complete insertion of the card and to provide an early warning of extraction upon commencement of extraction. One arrangement for doing so is shown in FIG. 1. As can be seen in FIG. 1A, one of the pins on one of the connectors is made shorter than the other pins (in the example of FIG. 1, one of the end pins of the middle connector). Upon insertion of the circuit card (FIG. 1B), this short pin will be the last pin to make electrical contact with its corresponding hole. Connection detection circuitry (typically on the circuit card but also possible on the backplane) detects electrical contact between the short pin and its corresponding hole, and only then alerts the system that the circuit card is fully inserted. When the card is extracted the short pin is the first pin to lose electrical contact with its corresponding hole, and as soon as the connection detection circuitry detects this loss of electrical contact it alerts the system that the card is being extracted.

While the use of a short pin provides a mechanical arrangement that detects full insertion and provides early warning upon extraction of the card, the mechanical arrangement requires a special male connector. The use of two different types of connector, one with all pins the same length and one with one pin being shorter than the other, adds cost to the backplane. In addition the male connectors are typically located on the larger of the circuit cards being connected, such as a motherboard or backplane. This means that the short pin is located on the backplane, and the more varied circuit cards which can be inserted on to the backplane must be designed taking into account the fixed location of the short pin. For example, a backplane may have four rows of three male connectors, the middle connector of each row having a short pin at one end. Although such a backplane can thereby support up to four circuit cards, the circuitry on these cards must be designed taking into account the length and position of the short pin.

Another problem with reliance on use of a short pin is that some backplanes may not have short pins on their connectors, particularly in some legacy systems.

A mechanical arrangement which provided for complete card insertion detection and early warning of card extraction without relying on the use of pins of different lengths would allow greater flexibility in the design of circuit cards, and would allow insertion detection and extraction warning for legacy backplanes which do not have short pins.

### SUMMARY OF THE INVENTION

In accordance with one aspect of the invention, a circuit card is provided. The circuit card includes at least one non-recessed connector extending a first distance from the edge of the circuit card, and at least one recessed connector extending a second distance from the edge of the circuit card, the second distance being shorter than the first distance. The second distance is preferably shorter than the first distance by an amount sufficient to distinguish the time of electrical contact of the non-recessed connectors with corresponding connectors on a second circuit card from the time of electrical contact of the recessed connectors with corresponding connectors on the second circuit card. The circuit card may include insertion/extraction detection circuitry for detection insertion of the circuit card onto a second circuit card upon the recessed connectors making electrical contact with corresponding connectors on the second circuit card and for detection of extraction of the circuit card upon the recessed connectors losing electrical contact with the corresponding connectors.

The card may be used for detection of full insertion of the circuit card onto a second circuit card, and for early detection of extraction of the circuit card from the second circuit card by reason of the recessed connectors.

The apparatus of the present invention allow flexibility in the design of circuit cards, since the design need not take into account the location of a short pin. The design may recess any of the connectors on the card, and the choice of which connector to recess and which electrical contact or contacts to monitor by the card extraction and insertion circuitry is dictated by the rest of the circuitry on the card rather than on hardware arrangements on the backplane onto which the card is to be inserted. The use of a recessed connector also gives the design of the circuit card full control over the amount of reduced mating length, or “wipe”, of the last-make-first-break contacts, rather than relying on the length of a short pin set by the design of the backplane. In addition, the mechanical arrangement of the invention allows card extraction and insertion circuitry to be used even when the card is to be inserted into systems which do not use a short pin, such as some legacy systems.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of a circuit card connection arrangement; and

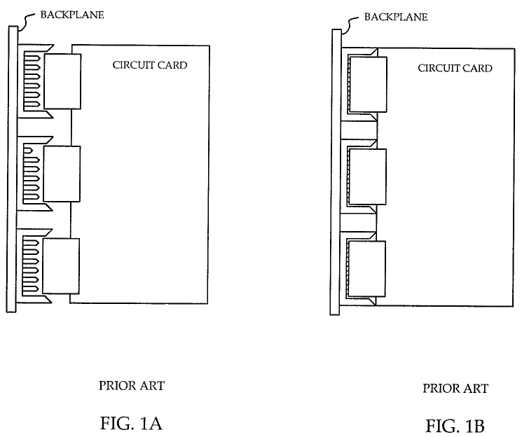

FIG. 2 is a diagram of a circuit card connection arrangement according to one embodiment of the invention.

It will be noted that in the attached figures, like features bear similar labels.

### DETAILED DESCRIPTION OF THE EMBODIMENTS

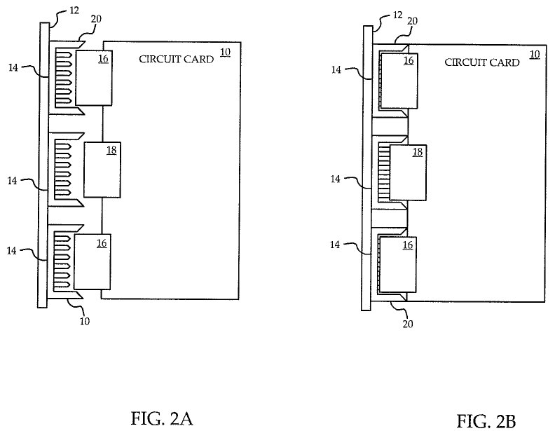

Referring to FIG. 2, a circuit card connection arrangement according to one embodiment of the invention is shown. A first circuit card 10 is to be inserted into a second circuit card 12, the second circuit card 12 being depicted edge-on in FIG. 2. The second circuit card 12 may be a motherboard or a backplane, but more generally may be any circuit card onto which at least one other circuit card is inserted. It should be noted that although the two circuit cards are shown as being oriented at right angles to each other, it is also possible that the circuit cards are connected edge-on, in other words that the connectors on the second circuit card 12 are along the edge of the second circuit card 12 and the two circuit cards are co-planar when one is inserted onto the other.

The second circuit card 12 includes at least two male connectors (the example circuit card of FIG. 2 having three male connectors), each of which includes a number of pins. As can be seen clearly in FIG. 2A, in which the first circuit card 10 has not yet been inserted, all of the pins of each male connector 14 are the same length.

The first circuit card 10 includes at least two female connectors 16 and 18. One of the female connectors 18 is recessed relative to the other female connectors 16, in that it extends out from the edge of the first circuit card 10 a shorter distance than do the other female connectors 16. It should be noted that although the first circuit card 10 and the second circuit card 12 are shown in FIG. 2 as each having the same number of connectors, this need not be the case.

Each male connector 14 may have card guides 20 projecting perpendicular to the second circuit card 12 so as to guide the connectors 16 and 18 upon insertion of the first circuit card 10 onto the second circuit card 12.

The non-recessed female connectors 16 generally extend from the edge of the first circuit card 10 to the same degree as each other and by a length dictated by the size of the card guides, so that when the first circuit card 10 is fully inserted onto the second circuit card 12 the non-recessed female connectors lie substantially flush with the male connectors so as to maximize electrical contact between the non-recessed connectors 16 and the corresponding pins of the male connectors. However, this is not necessary for implementation of the invention as long as reliable electrical contact is established between the connectors of the first circuit card 10 and the corresponding pins.

FIG. 2B illustrates the circuit card arrangement when the first circuit card 10 is fully inserted onto the second circuit card 12. The difference between the distances by which the non-recessed connectors 16 and the recessed connector 18 extend from the edge of the first circuit card 10 is sufficient to distinguish a time of electrical contact of the non-recessed connectors with the corresponding connectors on the second circuit card from a time of electrical contact of the recessed connector 18 with the corresponding connector on the second circuit card 12 when the first circuit card 10 is inserted onto the second circuit card 12. The difference in electrical contact time may be sufficiently distinct to provide warning upon insertion or extraction, or simply sufficiently distinct to ensure that the recessed connector is the last connector to make contact upon insertion of the first circuit card 10 and the first connector to break contact upon removal of the first circuit card 10.

The recessed female connector 18 makes electrical contact with the pins of its corresponding male connector 14, but as is clear this electrical contact will occur later than the electrical contact made for the other female connectors 16 of the first circuit card 10 when the first circuit card 10 is inserted onto the second circuit card 12. By the time insertion detection circuitry (not shown) detects electrical contact for any of the pins on the recessed connector 18, the other female connectors 16 will have established full electrical contact with their corresponding pins. Actions which require full insertion, such as powering up of the first circuit card 10, can then be started.

When the first circuit card 10 is extracted from the second circuit card 12, the electrical contact of the recessed connector 18 will break before the electrical contact of the other female connectors 16. Extraction detection circuitry (not shown) detects breaking of the electrical contact for the recessed connector 18 while the remaining female connectors 16 still have electrical contact with their corresponding pins. The extraction detection circuitry provides warning to other circuitry that the first circuit card 10 is being extracted, and appropriate actions can be taken by the other circuitry.

The degree to which the recessed connector 18 is recessed will depend on a balance of criteria which can be determined by the designer of the first circuit card 10. A mechanical analysis can be performed to optimize the trade-off between (1) greater recess which better indicates how fully inserted the card is, provides more warning on card extraction, and provides more tolerance for variation in the card guides, and (2) less recess which maximizes wipe of the contacts so as to provide a good electrical connection. It should be noted that this kind of balance is generally not possible with the use of a short pin, since the amount of wipe is determined by the design of the second circuit card 12 rather than the design of the first circuit card 10 and it is the first circuit card 10 which has more variation in type and design.

The invention has been described as using one recessed female connector. More generally any number of the connectors on the card which is to be inserted may be recessed and the insertion/extraction detection circuitry may monitor for establishment/breaking of electrical contact for any number of such recessed connectors, as long as there is at least one recessed connector and at least one non-recessed connector on the card being inserted. For example, a recessed connector at each end of the card can improve reliability of the insertion/extraction detection circuitry in systems where lateral movement of the card within the card guides is an issue.

The invention has been described with female connectors on the first circuit card 10 and male connectors on the second circuit card 12. Alternatively, the male and female connectors could be reversed, that is the male connectors placed on the circuit card being inserted. In such an embodiment one of the male connectors on the circuit card being inserted would be recessed relative to the other male connectors on the circuit card. As yet another alternative, there could be a mix of male and female connectors on one card and a corresponding mix of female and male connectors on the other card. Although convention usually places the male connectors on the main circuit card onto which other circuit cards are inserted, advantages of the invention are realized as long as at least one connector of either type is recessed on the card being inserted.

The embodiments presented are exemplary only and persons skilled in the art would appreciate that variations to the embodiments described above may be made without departing from the spirit of the invention.

We claim:

1. A circuit card comprising:
at least one non-recessed connector extending a first distance from the edge of the circuit card; and
at least one recessed connector extending a second distance from the edge of the circuit card, the second distance being shorter than the first distance.

2. The circuit card of claim 1 comprising a plurality of non-recessed connectors.

3. The circuit card of claim 1 comprising a plurality of recessed connectors.

4. The circuit card of claim 3 comprising two recessed connectors, one recessed connector at each end of the edge on which the connectors are located.

5. The circuit card of claim 1 further comprising insertion detection circuitry which detects insertion of the circuit card onto a second circuit card upon the at least one recessed connector making electrical contact with corresponding connectors on the second circuit card.

6. The circuit card of claim 5 further comprising extraction detection circuitry which detects extraction of the circuit card from the second circuit card upon the at least one recessed connector losing electrical contact with corresponding connectors on the second circuit card.

7. The circuit card of claim 6 comprising a plurality of non-recessed connectors.

8. The circuit card of claim 7 comprising a plurality of recessed connectors.

9. The circuit card of claim 8 comprising two recessed connectors, one recessed connector at each end of the edge on which the connectors are located.

10. The circuit card of claim 1 further comprising extraction detection circuitry which detects extraction of the circuit card from a second circuit card upon the at least one recessed connector losing electrical contact with corresponding connectors on the second circuit card.

11. The circuit card of claim 1 wherein the second distance is shorter than the first distance by an amount sufficient to distinguish a time of electrical contact of the at least one non-recessed connector with corresponding connectors on a second circuit card from a time of electrical contact of the at least one recessed connector with corresponding connectors on the second circuit card when the circuit card is inserted onto the second circuit card.

12. The circuit card of claim 11 further comprising insertion detection circuitry which detects insertion of the circuit card onto the second circuit card upon the at least one recessed connector making electrical contact with corresponding connectors on the second circuit card.

13. The circuit card of claim 12 further comprising extraction detection circuitry which detects extraction of the circuit card from the second circuit card upon the at least one recessed connector losing electrical contact with corresponding connectors on the second circuit card.

14. The circuit card of claim 13 comprising a plurality of non-recessed connectors.

15. The circuit card of claim 13 comprising a plurality of recessed connectors.

16. The circuit card of claim 15 comprising two recessed connectors, one recessed connector at each end of the edge on which the connectors are located.

17. The circuit card of claim 11 further comprising extraction detection circuitry which detects extraction of the circuit card from the second circuit card upon the at least one recessed connector losing electrical contact with corresponding connectors on the second circuit card.

18. Use of the circuit card of claim 1 for detection of full insertion of the circuit card onto a second circuit card and for early detection of extraction of the circuit card from the second circuit card, by reason of the at least one recessed connector.
